(19) United States
(12) Patent Application Publication
(10) Pub. No.: US 2022/0172111 A1
(43) Pub. Date: Jun. 2, 2022

(54) DATA PREPARATION FOR USE WITH MACHINE LEARNING

(71) Applicant: Amazon Technologies, Inc., Seattle, WA (US)

(72) Inventors: Yuqing Gao, Bellevue, WA (US); Laurence Louis Eric Rouesnel, New York, NY (US); Ajai Sharma, Los Altos, CA (US)

(21) Appl. No.: 17/359,382

(22) Filed: Jun. 25, 2021

Related U.S. Application Data
(60) Provisional application No. 63/119,282, filed on Nov. 30, 2020.

(51) Int. Cl. G06N 20/00

(52) U.S. Cl. CPC G06N 20/00

(57) ABSTRACT

Systems and methods to obtain a text-based representation of a machine learning (ML) graph identifying one or more transforms usable to prepare data for ML training. The systems and methods can determine computer-executable instructions based on the text-based representation of the ML graph, where the computer-executable instructions can include instructions associated with the one or more transforms to prepare data for ML training. Additionally, the systems and methods can process the computer-executable instructions to generate ML training data based on at least the one or more transforms.

### CROSS-REFERENCE TO RELATED APPLICATION

This application claims the benefit of U.S. Provisional Patent Application No. 63/119,282, filed Nov. 30, 2020, entitled “MACHINE LEARNING DATA PREPARATION FRONT END AND BACK END,” the disclosure of which is incorporated herein by reference in its entirety.

### BACKGROUND

There are many challenges that inhibit data scientists from analyzing and preparing data for machine learning (ML) in an efficient manner. For example, in many cases, data scientists are not able to easily connect to various data sources. Furthermore, it may be difficult to configure various tools to perform data-science-specific transforms to accelerate data cleansing, transformation, and feature engineering. There are many challenges involved in data preparation, and it is difficult to make such steps fully automated and reproducible.

### BRIEF DESCRIPTION OF THE DRAWINGS

Various techniques will be described with reference to the drawings, in which:

FIG. 1 illustrates a computing environment that allows users, such as data scientists, to generate and process data preparation workflows, according to at least one embodiment;

FIG. 2 illustrates another computing environment that allows users, such as data scientists, to generate and process data preparation workflows, according to at least one embodiment;

FIG. 3 illustrates a graph displayed in a user interface (UI), according to at least one embodiment;

FIG. 4 illustrates an example flow diagram that may be associated with one or more of the described system environments, for generation and use of graphs to produce modified data usable for training machine learning models, according to at least one embodiment;

FIG. 5 illustrates another example flow diagram that may be associated with one or more of the described system environments, for generation and use of graphs to produce modified data usable for training machine learning models, according to at least one embodiment;

FIG. 6 illustrates yet another example flow diagram that may be associated with one or more of the described system environments, for generation and use of graphs to produce modified data usable for training machine learning models, according to at least one embodiment; and

FIG. 7 illustrates a system in which various embodiments can be implemented.

### DETAILED DESCRIPTION

Techniques described herein may be utilized to implement systems and methods relating to machine learning (ML). As described in greater detail below, an interactive graphical user interface (UI) for an ML data preparation environment is provided for data scientists to analyze and prepare data for ML applications and system use. Using techniques described herein, data scientists can easily connect to various data sources and leverage a suite of built-in data-science-specific transforms to accelerate data cleansing, transformation, and feature engineering. A plugin integrated into an integrated machine learning environment registers and persists data preparation steps. These data preparation steps can include data extraction, data joins, data cleansing, and data transforms.

The data preparation steps can be graphically displayed in the graphical UI of the ML data preparation environment. The data preparation steps can be displayed as nodes of a graph graphically displayed in the graphical UI of the ML data preparation environment. Each node of the graph can include an underlying syntax, such as textualized syntax or human-readable text, specifying input(s), output(s), a node identifier (ID), one or more parameters, and one or more functions. The underlying syntax can be used to generate computer-executable instructions, such as Python or other suitable computer code language, which can be executed to generate data, such as a modified or conditioned data according to the one or more functions, that can be used to train an ML model. Generating the computer-executable instructions can be facilitated by a backend service, such as a kernel service running on more compute resources, connected to a frontend that provides the integrated ML environment. For example, the backend service can receive underlying data associated with one or more of the nodes of the graph, and the backend service can convert the underlying data to computer-executable instructions that are executable to perform the data preparation steps graphically represented by the one or more nodes of the graph.

A plugin described herein can be an interactive plugin of an integrated machine learning environment that leverages Jupyter and JupyterLab extensions to build rich user interfaces for ML data preparation tasks. Various components may be utilized to enable rich ML scenarios, including the UI for interactive data selection, graph design for data transformation steps or actions, and product ionization. Various UI components, such as graph nodes, can send textualized requests to a backend service to generate computer-executable instructions, execute application logic, and/or perform compute tasks. A data selection service can be implemented in the context of a backend service for the interactive data select user experience (UX). A data transformation service may be implemented in the context of a backend service to handle requests from graph design UX and may delegate computation work to a compute engine and integrate with other dependent services, such as an ML data transformation pipeline service. Various compute components may include a compute engine to manage graph building and computations, and a runtime container image built on top of an ML service that can process job container images. Images may be used for an interactive session in an integrated machine learning environment or for batch execution.

In various described embodiments, a UI is provided to allow a user, such as a data scientist, to generate a data preparation workflow that can be used to prepare data usable for one or more ML applications or ML implementations. In an example, the data prepared in accordance with the data preparation workflow can be used to train an ML model. The data preparation workflow can be accessed by multiple users simultaneously, and the data preparation workflow can be associated with a frontend, such as a UI associated with a web browser. Several frontends, operated by various data scientists, can access the data preparation workflow to augment, troubleshoot, modify, save, and/or deploy the data preparation workflow. In at least one embodiment, one or more funding computing devices are the one or more sources of truth for the data preparation workflow.

The data preparation workflow can be graphically displayed in the UI as a graph structure, often just referred to herein as a graph or a logical graph. The graph can include one or more nodes. In an example, the one or more nodes can include a node for a data source that includes data to be modified by operations of the data preparation workflow and subsequently used to train an ML model. There can be multiple data source nodes. Data associated with respective data source nodes can be joined, merged, or concatenated through user selectable options of the UI. Data from respective data source nodes joined, merged, or concatenated can be displayed as a node of the graph graphically displayed in the UI.

The UI can offer one or more data transformations that can be applied to data associated with a data source node of the data preparation workflow. Once the data source node is associated with the graph structure, a data scientist interfacing with the UI can quickly access, graphically, the one or more data transformations to apply to the data associated with the data source node. These one or more data forms can include a featurize text transform, a character statistics transform, a format string transform, a handle outliers transform, a handle missing values transform, and so forth. Further details of the one or more data transforms provided in the UI are described hereinafter.

The UI that allows users to generate the data preparation workflow can also include user selectable options to analyze data associated with the one or more data source nodes. The user selectable options can allow a data scientist to add an analysis option that causes the data preparation workflow to display a quick summary for the data associated with the one or more data source nodes. The quick summary can include a number of entries, such as rows and/or columns, in the data. Alternatively, or in addition, the quick summary can include minimum and maximum values for numeric data in the data associated with one or more data source nodes. Furthermore, the quick summary can include generating a concise ML model and scoring for features of the concise ML model, based on the data associated with the one or more data source nodes. Furthermore, the quick summary can include a target leakage report associated with the data, which can allow a data scientist to determine if one or more features of the data are strongly correlated to a target feature. The UI that allows users to generate the data preparation workflow can also include an option that allows a data scientist to define, through a script language or the like, custom analysis routines to perform on the data associated with one or more data source nodes.

The UI that allows users to generate the data preparation workflow can also include user selectable options to visualize data associated with the one or more data source nodes. The user selectable options can allow a data scientist to add a visualization option that causes the data preparation workflow to display a visualization for the data associated with the one or more data source nodes. In an example, a visualization option that can be associated with the one or more data source nodes includes an option to generate a histogram of the data associated with the one or more data source nodes. In another example, a visualization option that can be associated with the one or more data source nodes includes an option to generate a scatterplot of the data associated with the one or more data source nodes. The UI that allows users to generate the data preparation workflow can also include an option that allows a data scientist to define, using computer-executable instructions such as computer code, one or more custom visualizations for the data associated with the one or more data source nodes.

As described in the foregoing, a data preparation workflow, created by a data scientist using the UI of the integrated ML environment, can be in the form of a graphically displayed graph that includes one or more nodes. In an example, the graph can include a first node for a selected data source that includes the data that is to be prepared and/or modified in preparation for use in one or more ML operations or tasks, such as for use in training an ML model. The first node can correspond to data from multiple datasets to be jointed, merged, or concatenated according to a user selectable transform of the UI. The graph can also include a second node linked to the first node, where the second node is associated with one or more user selected transforms, such as for conditioning the data, that is to be performed on the data in preparation for use in the one or more ML operations or tasks. The graph, including the first and second node, is described by way of example only. Specifically, the graph can include any number of nodes, which are caused to be included in the graph by a data scientist using the UI of the integrated ML environment.

The UI that allows users to generate the data preparation workflow can include one or more user selectable options to export the data preparation workflow. For example, the foregoing described graph with the first and second nodes can be converted to computer-executable instructions, such as computer code, through a user selectable option of the UI. Specifically, each of the first and second nodes includes underlying data. This underlying data can be textualized data, simple text, script language, human-readable syntax, JavaScript Object Notation (JSON) syntax, YAML syntax, and/or XML syntax. The processing engine of the UI can be implemented to recognize the underlying data of the first and second nodes and convert that underlying data, based on the one or more user selectable options to export the data preparation workflow, to an exportable format that corresponds to an export option selected by the data scientist. In another option, the processing engine of the UI can convey the underlying data of the data preparation workflow to a backend interface, such as one or more servers or virtual machines, that processes the underlying data based on an export option selected by the data scientist. One option for exporting the data preparation workflow converts the underlying data of the data preparation workflow to a Jupyter notebook. Another option for exporting the data preparation workflow converts the underlying data of the data preparation workflow to an ML pipeline. Yet another option for exporting the data preparation workflow converts the underlying data of the data preparation workflow to computer-executable instructions, such as Python code. In yet another option for exporting, the data preparation workflow moves the underlying data of the data preparation workflow to a computer storage location.

Conventionally, preparing data for ML purposes, such as ML model training, is a process that involves the use of significant computer resources and consumes many data scientist manhours. In accordance with the foregoing and the elaborations provided in the following, the described techniques allow data scientists to quickly connect to various data sources, analyze data stored in those data sources, and prepare the data for ML tasks. Data scientists can interact with a simple-to-use and intuitive UI to explore, transform, and prepare data that can be used to train ML models. Tools provided by the UI allow data scientists to create a visual representation of a data transformation flow that can be processed by compute resources of a backend service to prepare data for training ML models. Such a backend service can be offered by an online service provider that provides a variety of services, including at least distributed compute resources in association with one or more services.

In the preceding and following descriptions, various techniques are described. For purposes of explanation, specific configurations and details are set forth in order to provide a thorough understanding of possible ways of implementing the techniques. However, it will also be apparent that the techniques described below may be practiced in different configurations without the specific details. Furthermore, well-known features may be omitted or simplified to avoid obscuring the techniques being described.

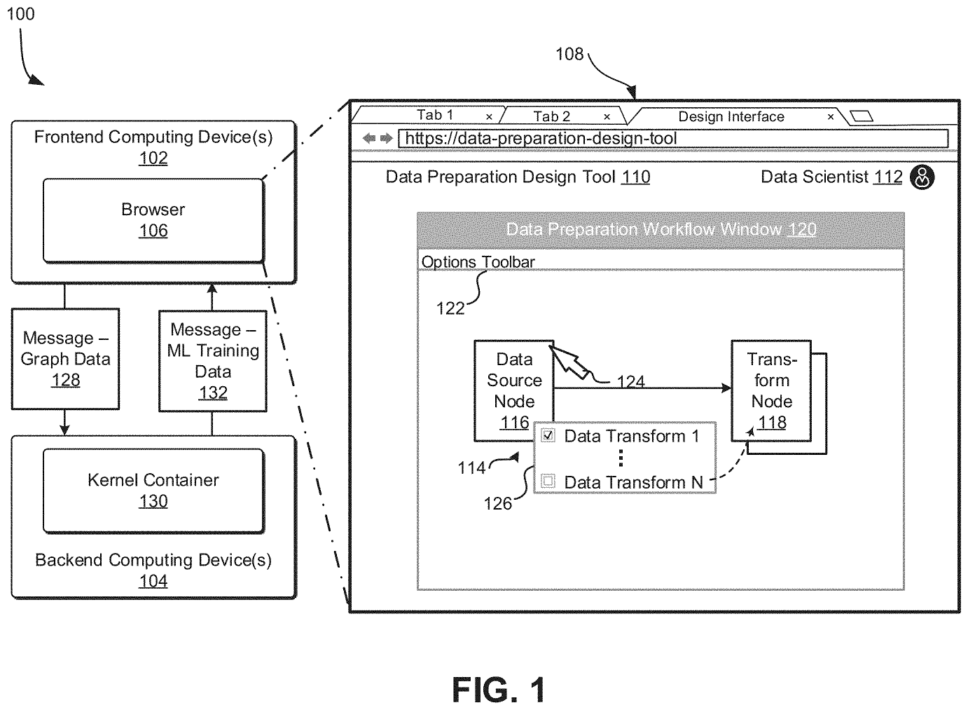

FIG. 1 illustrates a computing environment 100 that allows users, such as data scientists, to generate and process data preparation workflows, in which at least one embodiment can be practiced. The computing environment 100 can include one or more frontend computing devices 102 and one or more backend computing devices 104. The one or more frontend computing devices 102 can include one or more processors and one or more computer storages, such as volatile and/or nonvolatile memory. The one or more computer storages can store computer-executable instructions, such as computer code, that the one or more processors can execute in order to realize the described techniques associated with at least one of the described embodiments. Similarly, the one or more backend computing devices 104 can include one or more processors and one or more computer storages, such as volatile and/or nonvolatile memory. The one or more computer storages of the one or more backend computing devices 104 can store computer-executable instructions, such as computer code, that the one or more processors can execute in order to realize the described techniques associated with at least one of the described embodiments.

In at least one embodiment, the frontend computing device 102 is a client computing device that has authorized access, according to provided credential information, to the backend computing device 104. Furthermore, in at least one embodiment, the backend computing device 104 can be associated with one or more services provided by an online service provider. In at least one embodiment, the backend computing device 104 is associated with a data preparation service provided by the online service provider. The data preparation service provided by the online service provider can generate, according to the described techniques, data that is modified, conditioned, and/or cleaned in preparation for using the data to train one or more ML models.

The frontend computing device 102 can display one or more UIs, such as a UI associated with a browser 106. According to at least one embodiment, the browser 106 can display a design UI 108 that offers a data preparation design tool 110. The data preparation design tool 110 can be accessed by a data scientist, such as the data scientist 112 identified in the design UI 108. In at least one embodiment, the data scientist 112 authenticates with the backend computing device 104 to obtain access to the data preparation design tool 110. The authentication process triggered by the data scientist 112 can include an exchange of credential information between the frontend computing device 102 and the backend computing device 104. The credential information can include username and password information provided by the data scientist 112, an access key provided by the data scientist 112, or any other suitable access information recognized by the backend computing device 104 and authentication services implemented by the backend computing device 104.

The data scientist 112 can use the data preparation design tool 110 to create a data preparation workflow 114, also referred to herein as a data preparation flow, logical graph, graph, and/or flow. In a nonlimiting example, according to at least one embodiment, the data scientist 112 can use the data preparation design tool 110 to generate the graph 114 to include a first node 116 and a second node 118. The graph 114 can be generated to include any number of nodes. In at least one embodiment, the first node 116 is a data source node and the second node 118 is a transform node 118. Details of the data source node 116 and the transform node 118 are provided in the following description.

The data scientist 112, in at least one embodiment, can use an options toolbar 122 associated with a data preparation workflow window 120 to add nodes to the graph 114. In an example, the data scientist 112 uses the options toolbar 122 to add the data source node 116 to the graph 114. When the data scientist 112 uses the data preparation design tool 110 and the options toolbar 122 to add the data source node 116, the tool 110 can prompt the data scientist 112 to identify a computer storage location, such as a computer directory or folder, that includes data to be modified, conditioned, and/or cleaned in preparation for using the data to train one or more ML models. In at least one embodiment, the data for training the one or more ML models can be included in a database. The database can comprise one or more tables. The one or more tables can include one or more columns and one or more associated rows associated with the data in the database. In an embodiment, the data preparation design tool 110 supports processing data contained in CSV and/or Parquet files. The data scientist 112 can access the options toolbar 122 using a pointer 124, which is caused to be moved by an accessory, such as a mouse or other accessory device, in communication with the frontend computing device 102. In addition to prompting the data scientist 112 to identify the computer storage location of the data to be prepared to train the ML model, the tool 110 can prompt the data scientist 112 to create a query script that can be run by the data preparation design tool 110 to select data in the data to be prepared to train the ML model.

The data source node 116 is displayed graphically in the data preparation workflow window 120. In at least one embodiment, the frontend computing device 102, facilitated by the data preparation design tool 110, stores a syntax representation of the data source node 116. The syntax representation of the data source node 116 can be textualized data corresponding to the data source node 116, a text-based representation associated with the data source node 116, human-readable syntax associated with the data source node 116, human-readable text corresponding to the data source node 116. In at least one embodiment, the syntax representation of the data source node 116 is any syntax representation other than computer-executable instructions. In at least one embodiment, the syntax representation of the data source node 116 is formatted in HyperText Markup Language (“HTML”), XML, JSON, and/or another script-like syntax that can be parsed and understood by a human or a machine with artificial intelligence at least equaling an average human intelligence level. In at least one embodiment, all nodes associated with a graph, such as the graph 114, will each have an underlying associated syntax representation.

In at least one embodiment, the syntax representation of the data source node 116 identifies the storage location that includes the data to be modified, conditioned, and/or cleaned in preparation for using the data to train the one or more ML models. In addition, in at least one embodiment, the syntax representation of the data source node 116 includes a node ID assigned to the data source node 116. The node ID can be an alphanumeric value, a numeric value, a hash value, or the like. The syntax representation of the data source node 116 can identify one or more selected data types in accordance with a query script selected or composed by the data scientist 112 when the data source node 116 was added to the graph 114. In at least one embodiment, the syntax representation of the data source node 116 can be updated based on an action, initiated by the data scientist 112, that updates the functionality of the data source node 116 via the options toolbar 122. In at least one embodiment, the data preparation design tool 110 automatically infers, based on analysis of the data to be prepared to train the ML model, one or more data types associated with the data. Furthermore, in at least one embodiment, the data preparation design tool 110 can add a distinct node, coupled to the data source node 116, that corresponds to the one or more data types associated with the data based on automatic inference performed by the data preparation design tool 110 and/or one or more queries crafted or selected by the data scientist 112. Such a distinct node can include underlying or associated syntax identifying the one or more selected or inferred data types.

The data preparation design tool 110 can be used to assign one or more processing actions to perform on the data selected by the data scientist 112 and associated with the data source node 116. In at least one embodiment, the data scientist 112 can use the pointer 124 to access the one or more processing actions that can be performed on the data selected by the data scientist 112. In at least one embodiment, the data scientist 112 can display the selectable one or more processing actions by right clicking on the data source node 116, or by accessing the options toolbar 122 of the data preparation workflow window 120. In at least one embodiment, the data scientist 112 can display the selectable one or more processing actions by clicking on another selectable option in the data preparation workflow window 120, such as a selectable icon displayed in the data preparation workflow window 120. In the illustrated example shown in FIG. 1, the one or more processing actions are displayed as a plurality of data transforms within a sub-window 126 of the data preparation workflow window 120.

In the illustrated example shown in FIG. 1, the data scientist 112 selects the data transform 1 from the window 126. Selecting the data transform 1 can cause the transform node 118 to be added to the graph 114. In addition, selecting the data transform 1 can cause the data preparation design tool 110 to generate a syntax representation of the transform node 118. The data preparation design tool 110 can cause storage of a syntax representation of the transform node 118 in computer storage of the frontend computing device 102. The syntax representation of the transform node 118 can be textualized data corresponding to the transform node 118, a text-based representation associated with the transform node 118, human-readable syntax associated with the transform node 118, human-readable text corresponding to the transform node 118. In at least one embodiment, the syntax representation of the transform node 118 is any syntax representation other than computer-executable instructions. In at least one embodiment, the syntax representation of the transform node 118 is formatted HTML, XML, JSON, and/or another script-like syntax that can be parsed and understood by a human or a machine with artificial intelligence at least equaling an average human intelligence level. In at least one embodiment, all nodes associated with a graph, such as the graph 114, will each have an underlying associated syntax representation.

In at least one embodiment, the syntax representation of the transform node 118 identifies the function name linked or assigned to the data transform 1. In addition, in at least one embodiment, the syntax representation of the transform node 118 includes a node ID assigned to the transform node 118. The node ID can be an alphanumeric value, a numeric value, a hash value, or the like. The syntax representation of the transform node 118 can identify one or more node IDs associated with other nodes in the graph 114. For example, the syntax representation of the transform node 118 can identify the node ID associated with the data source node 116. In at least one embodiment, the syntax representation of the transform node 118 can identify a location of data that is to be modified, conditioned, transformed, and the like, in accordance with the data transform 1 associated with the transform node 118.

The data scientist 112 can indicate completion of the graph 114 through the data preparation workflow window 120. This can trigger the frontend computing device 102 to generate a message 128. The message 128 can be generated to include the syntax representation associated with the data source node 116 and/or the syntax representation associated with the transform node 118. The message 128 can be transmitted to the backend computing device 104. The message 128 can be processed by the backend computing device 104.

In at least one embodiment, the backend computing device 104 includes a kernel container 130 that can receive the message 128 and process the message 128 to access the syntax representation(s) contained therein. In at least one embodiment, the kernel container 130 is a type of software that can virtually package and isolate applications. The kernel container 130 can access an operating system (OS) kernel of the backend computing device 104. Moreover, the kernel container 130 can hold the components necessary to execute computer-executable instructions. These components can include files, environment variables, dependencies and libraries. The OS of the backend computing device 104 can control and facilitate the kernel container's 130 access to physical resources of the backend computing device 104, such as CPU, storage and memory.

The kernel container 130 can use the syntax representation(s) contained in the message 128 to generate a message 132 that is to be transmitted to the frontend computing device 102. In an example, the message 132 is generated to include modified, conditioned, and/or cleaned data that can be used to train an ML model. In at least one embodiment, the data to be included in the message 132 is processed according to one or more functions identified, such as by function name or function ID, in the syntax representation(s) contained in the message 128. For example, the function name or function ID can be used to locate and retrieve a function(s) that is executed by the kernel container 130 to modify, condition, and/or clean data stored by a computer storage of the backend computing device 104. The located function(s) can be stored in computer storage of the backend computing device 104. Furthermore, the data stored by the computer storage of the backend computing device 104 can be located using data storage location information included in the syntax representation(s) contained in the message 128.

In at least one embodiment, the message 132 can also include metadata. The metadata can specify one or more node IDs associated with the syntax representation(s) conveyed to the backend computing device 104 in the message 128. In at least one embodiment, an amount of data that can be used to train an ML model, including in the message 132, is determined by a mode selected by the data scientist 112. For example, the backend computing device 104 can include a limited amount of the overall data that can be used to train the ML model based on a mode selected by the data scientist 112 via the data preparation workflow window 120. In at least one embodiment, the data preparation design tool 110 allows data scientists, such as the data scientist 112, to toggle between various operational modes associated with the data preparation design tool 110. A first mode, such an analysis mode, can cause the backend computing device 104 to provide a subset, within the message 132, of the overall data that can be used to train an ML model. On the other hand, a second mode, such as a deploy mode, can cause the backend computing device 104 to provide, within the message 132, all of the data that can be used to train the ML model.

The message 128 can be received by the frontend computing device 102. The message 128, in at least one embodiment, is processed by the data preparation design tool 110. The data preparation design tool 110 can process the message 128 to retrieve the data, modified, conditioned, and/or cleaned based on the one or more of function calls executed by the backend computing device 104. The retrieved data can be displayed by the data preparation workflow window 120. Additionally, or alternatively, the frontend computing device 102 can use the data contained in the message 128 to train one or more ML models.

The data transforms provided by the data preparation design tool 110 can include the following transforms. Other data transforms can be provided by the data preparation design tool 110.

Join datasets transforms: These data transforms can be used to join at least two separate data sets. (a) Left Outer—Include all rows from the left table. If the value for the column joined on a left table row does not match any right table row values, that row contains null values for all right table columns in the joined table. (b) Left Anti—Include rows from the left table that do not contain values in the right table for the joined column. (c) Left semi—Include a single row from the left table for all identical rows that satisfy the criteria in the join statement. This excludes duplicate rows from the left table that match the criteria of the join. (d) Right Outer—Include all rows from the right table. If the value for the joined column in a right table row does not match any left table row values, that row contains null values for all left table columns in the joined table. (e) Inner—Include rows from left and right tables that contain matching values in the joined column. (f) Full Outer—Include all rows from the left and right tables. If the row value for the joined column in either table does not match, separate rows are created in the joined table. If a row doesn't contain a value for a column in the joined table, null is inserted for that column. (g) Cartesian Cross—Include rows which combine each row from the first table with each row from the second table. This is a Cartesian product of rows from tables in the join. The result of this product is the size of the left table times the size of the right table.

Concatenate datasets transform: This data transform joins a dataset to the end of another dataset.

Encode categorical transform: Categorical data is usually composed of a finite number of categories, where each category is represented with a string. For example, a table of customer data that includes a column that indicates the country a person lives in is an example of categorical data. The categories would be Afghanistan, Albania, Algeria, and so on. Categorical data can be nominal or ordinal. Ordinal categories have an inherent order, and nominal categories do not. The highest degree obtained (High school, Bachelors, Master) is an example of ordinal categories.

Encoding categorical data is the process of creating a numerical representation for categories. For example, if the categories are Dog and Cat, this information can be encoded into two vectors, [1,0] to represent dog, and [0,1] to represent cat.

When encoding ordinal categories, it may be necessary to translate the natural order of categories into your encoding. For example, the highest degree obtained can be represented with the following map: {“High school”: 1, “Bachelors”: 2, “Masters”: 3}.

Use categorical encoding to encode categorical data that is in string format into arrays of integers.

The categorical encoders create encodings for all categories that exist in a column at the time the step is defined. If new categories have been added to a column when the data preparation design tool job is started to process your dataset at time t, and this column was the input for a categorical encoding transform at time t−1, these new categories are considered missing in the job. An invalid handling strategy can be applied to these missing values.

Ordinal encode transform: This transform encodes categories into an integer between 0 and the total number of categories in the input column selected.

Featurize text transform: Use the Feature Text transform group to inspect string typed columns and use text embedding to featurize these columns. This feature group contains two features, character statistics and vectorize.

Character statistics transform: Use the character statistics transform to generate statistics for each row in a column containing text data. This transform computes the following ratios and counts for each row, and creates a new column to report the result. The new column is named using the input column name as a prefix and a suffix that is specific to the ratio or count. Number of words: The total number of words in that row. The suffix for this output column is -stats word count. Number of characters: The total number of characters in that row. The suffix for this output column is -stats_char_count. Ratio of upper: The number of upper-case characters, from A to Z, divided by all characters in the column. The suffix for this output column is -stats_capital_ratio. Ratio of lower: The number of lower-case characters, from a to z, divided by all characters in the column. The suffix for this output column is -stats_lower_ratio. Ratio of digits: The ratio of digits in a single row over the sum of digits in the input column. The suffix for this output column is -stats_digit_ratio. Special characters ratio: The ratio of non-alphanumeric (characters like #$&%:@) characters over the sum of all characters in the input column. The suffix for this output column is -stats_special_ratio.

Format string transform: The format string transform contains standard string formatting operations. For example, use this transform to remove special characters, normalize string lengths, and update string casing.

Handle outliers transform: ML models are sensitive to the distribution and range of your feature values. Outliers, or rare values, can negatively impact model accuracy and lead to longer training times. Use this feature group to detect and update outliers in a dataset. The handle outlier transform can process standard deviation numeric outliers, quartile numeric outliers, and min-max numeric outliers.

Handle missing values transform: Missing values are a common occurrence in ML datasets. In some situations, it is appropriate to impute missing data with a calculated value, such as an average or categorically common value. Such missing values can be addressed using the handle missing values transform group.

Fill missing transform: This transform can be used to fill missing values with a field value specified by a data scientist.

Impute missing transform: Use the impute missing transform to create a new column that contains imputed values where missing values were found in input categorical and numerical data. The configuration depends on your data type.

Manage columns transform: Use the manage columns transform to duplicate a column, rename a column, and move a column location in a data set.

Manage rows transform: use the manage rows transform to sort an entire data frame by given column or randomly shuffle a plurality of rows in a data set.

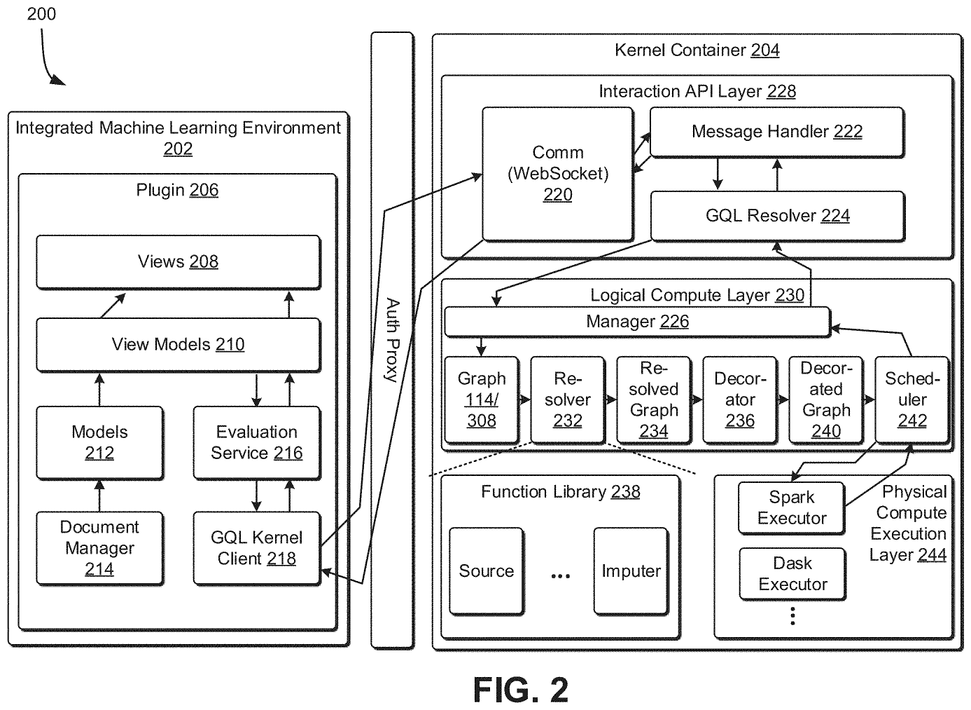

FIG. 2 illustrates another computing environment 200 that allows users, such as data scientists, to generate and process data preparation workflows, according to at least one embodiment. The computing environment 200 may include an integrated ML environment 202 that communicates with a kernel container 204. In at least one embodiment, the computing environment 200 can provide the same or nearly the same functionalities described in conjunction with the computing environment 100 illustrated in FIG. 1.

The integrated ML environment 202 can comprise software, in the form of computer-executable instructions, that can be used to build, train, deploy, and analyze machine learning models. Integrated machine learning environment may be a web-based, integrated development environment (IDE) for machine learning. The integrated ML environment 202 may be hosted within a web-based browser that includes one or more graphical user interface elements. The integrated ML environment 202 may be implemented as software that executes on a client computer system. A customer such as a data scientist may use a web-based browser to log in to an integrated machine learning environment and interact with a plugin from the web-based browser. In at least one embodiment, the integrated ML environment 202 is hosted by a client computing device, such as the frontend computing device 102 illustrated in FIG. 1.

A plugin 206 may refer to a component of the integrated ML environment 202. A plugin may be implemented as software within a webpage. A JupyterLab frontend plugin may be packaged as part of an integrated ML environment user interface and hosted on a shared JupyterLab application service. The plugin 206 may be a user interface built as a JupyterLab plugin that can view, edit, and manipulate graphs (e.g., add notes to graphs, etc.) as well as execute or evaluate graphs (e.g., by asking for an output on a node to be executed) by connecting to an execution backend, such as the kernel container 204. In at least one embodiment, the kernel container 204 is hosted by a backend computing device, such as the backend computing device 104 illustrated in FIG. 1.

Views 208 may refer to any suitable representation of information to be displayed within the plugin. In at least one embodiment described herein, the views 208 are implemented in React—however, this does not preclude other implementation in other embodiments, such as implementations that use PhosphorJS. A view 208 may refer to the structure, layout, and appearance of information and/or data that is displayed to a user. Data may be represented in various formats, such as charts, tables, and graphs. In various embodiments, the views provide graphical user interfaces (GUIs) which a user can interact with to import data from various sources such as data storage services, serverless, interactive query services, cloud data warehouse services, and more. The views 208 may provide graphical elements that a customer can interact with to export data to a job, to ML data transformation pipelines, to code, and more. The views 208 may be implemented in accordance with or at least in part based on software design patterns such as the model-view-view-model (MVVM) framework, model-view-controller (MVC) framework, model-view-presenter (MVP) framework, and any other suitable paradigm for separating the responsibilities of various components of a software application.

View models 210 may refer to an abstraction of the view exposing public properties and commands. A view model 210 may have a binder, which automates communication between the view and its bound properties in the view model 210. For example, the view model 210 may be described as a state of the data in the model. The view model 210 may be implemented in accordance with or at least in part based on software design patterns such as the model-view-view-model (MVVM) framework, or any other suitable paradigm for separating the responsibilities of various components of a software application. In at least some embodiments, in a MVVN model, a binder is used to automate communications between the view and its bound properties in the view model.

Models 212 may refer to an application's dynamic data structure, independent of the user interface. Models may directly manage the data, logic and rules of an application. A model may represent data in an object-oriented approach or a data-centric approach, or any other suitable approach to model data in the context of an application. In at least some embodiments, models 212 include a recipe model for JupyterLab documents. In at least some embodiments, models 212 interact with a data access layer, which may be represented as a document manager 214 as seen in FIG. 1. In at least some embodiments, a JupyterLab Document Manager provides recipes to the view model.

Evaluation service 216 may be used by the integrated ML environment 202 to evaluate graphs by connecting to an execution backend, such as a kernel container 204, as illustrated in FIG. 1. In at least one embodiment, evaluation service 216 sends requests, such as messages, to kernel container 204 using a kernel client 218. A kernel client 218 may be a GraphQL (GQL) kernel client 218. The GQL kernel client 218 may be used to submit requests or queries to a custom kernel, such as associated with the kernel container 204, hosted as a containerized image. In at least one embodiment, the frontend UI associated with the integrated ML environment 202 is used to make requests to an API layer 228. The API layer 228 may be implemented in any suitable manner—for instance, the API layer 228 may be implemented using GraphQL. In at least one embodiment, the API layer 228 expects a singleton runtime object that is used for all graph-related requests derived from messages received from the integrated ML environment 202.

A “container,” as referred to herein, packages up code and all its dependencies so an application (also referred to as a task) can run quickly and reliably from one computing environment to another. A container image is a standalone, executable package of software that includes everything needed to run an application process: code, runtime, system tools, system libraries and settings. Container images become containers at runtime. Containers are thus an abstraction of the application layer (meaning that each container simulates a different software application process). Though each container runs isolated processes, multiple containers can share a common operating system, for example by being launched within the same virtual machine. In contrast, virtual machines are an abstraction of the hardware layer (meaning that each virtual machine simulates a physical machine that can run software). Virtual machine technology can use one physical server to run the equivalent of many servers (each of which is called a virtual machine). While multiple virtual machines can run on one physical machine, each virtual machine typically has its own copy of an operating system, as well as the applications and their related files, libraries, and dependencies. Virtual machines are commonly referred to as compute instances or simply “instances.” Some containers can be run on instances that are running a container agent, and some containers can be run on bare-metal servers.

In the context of software containers, a “task” refers to a container, or multiple containers working together, running to execute the functionality of a software application or a particular component of that application. In some implementations, tasks can also include virtual machines, for example virtual machines running within an instance that hosts the container(s). A “task definition” can enable container images to be run in a cloud provider network to execute a task. A task definition can specify parameters including which container image to use with each container in the task, interactions between containers, constraints on container placement within a cloud provider network, what quantities of different hardware resources should be allocated to the task or to specific containers, networking modes, logging configurations, persistent storage that should be used with the containers in the task, and whether the task continues to run if a container finishes or fails. Multiple containers can be grouped into the same task definition, for example linked containers that must be run together to execute related processes of an application, containers that share resources, or containers that are required to be run on the same underlying host. An entire application stack can span multiple task definitions by separating different components of the application into their own task definitions. An application can be defined using a service definition, which can specify configuration parameters that define the service including which task definition(s) to use, how many instantiations of each task to run, and how the tasks should be load balanced.

The API layer 228 may include a comm (Web Socket) 220 which is used to send and receive custom messages between the integrated ML environment 202 and the kernel container 204. A message handler 222 of the API layer 228 may be a software component that subscribes to incoming messages from the comm 220 and dispatches it to a GQL resolver 224 or any suitable GraphQL API code bundled with the kernel associated with the kernel container 204. In an embodiment, a browser associated with the integrated ML environment 202 can send GQL query and mutation messages via Comm over a persisted kernel connection.

In at least one embodiment, a logical compute layer 230 of the kernel container 204 includes a manager 226. A data preparation runtime may include a stateless singleton object responsible for setting up execution runtime contexts (e.g., PySpark) and executing API requests. In at least one embodiment, the manager 226 takes one or more syntax representations associated with a graph, such as the graph 114, and compiles the one or more syntax representations into one or more executable forms that can be processed by a physical compute execution layer 244.

In at least one embodiment, the graph is taken as an input to a resolver 232. The graph may be assumed to be the entire graph that was generated in the integrated ML environment 202. The resolver 232 may resolve the graph into a task graph according to Dask, Spark, or any other suitable executor. The resolver 232 may, for example, translate function names to the actual function methods, as well as supply function parameters for each node of the graph to produce a resolved graph 234. The resolver 232 can leverage a function library 238 to obtain the actual function methods. A decorator 236 may add decorator layers. Decorators, or side effects, are added to the executable graph to produce a decorated graph 240. Once the decorated graph 240 is generated, the runtime may execute using Dask, Spark, or any other suitable executor, facilitated by a scheduler 242, to handle task dependency management and scheduling.

A primitive of the kernel container 204 can be an operator function(s) and an operator context(s). Operator functions may be pure functions that are effectively lazily curried Python methods, or similar methods, and operator contexts may act as a storage for runtime attributes that are supplied when the methods are invoked. This allows for runtimes to add decorators (as described in greater detail below) that use runtime attributes that act as a side effect to the invocation but does not affect the invocation results.

As noted above, a graph, such as a logical graph, may be computed to a task graph according to Dask, Spark, pandas, or any other suitable executor. An example of syntax associated with a graph node is provided below:

```
{
  “node_id”: “node-02”,
  “operator”: “sagemaker.spark.rename_column_0.1”,
  “inputs”: [{“name”: “default”, “node_id”: “node-01”, “output_name”:
  “default”}],
  “outputs”: [{“name”: “default”}],
  “parameters”: {“column”: “Cabin”, “new_name”: “Compartment”},
},
```

In at least one embodiment, each Dask task can require a task ID, a task function, and task input dependencies. For nodes in a logical graph, the “node_id” is reused for the “task_id.” Using the function name from “function,” the relevant operator function is used as the task function. The operator functions are also supplied the parameters from the logical graph to be used at invocation. Inputs may be specified by resolving the “inputs” described above. For example, input items may be resolved as “{node_id}#{output_name}.” In order to supply the correct input to tasks, output extractors are added after each task. An output extractor may be an object that grabs the specified output. For outcomes for target node outputs, a head node is added after the specified “{node_id}#{output_name}” task. This head node may be responsible for limiting the total outcome and returning a pandas DF to the API layer 228 to be returned to the frontend, such as the integrated ML environment 202.

Decorators, or invocation side effects, may be added as wrappers around the core invocations of the task graph functions. Decorators, in at least some embodiments, do not impact the results in at least some cases. Decorators may include caching, error handling, persistent results, and debugging. Regarding caching, because operator functions are stateless functions, arguments used for invocation can be hashed and used as a cache key. If the hash of the arguments exists in the cache, the decorator simply returns the cache result. Other cache implementations may be contemplated within the scope of this disclosure. Error handling decorator may propagate errors if any of the inputs provide error responses. Otherwise, the decorator may wrap the core invocation in a try-except clause to handle errors in responses. Regarding persistent results decorator, results may be persisted to an external store (e.g., any suitable data storage service) which may be particularly useful for long running tasks. Debugging decorators may be used for debugging and log inputs for each task, keeping track of which decorators are added, monitoring and benchmarking tasks, and so on.

An architecture in accordance with at least one embodiment includes a place to host a Python GraphQL API server that the integrated ML environment 202 can send requests to. The API server may also have access to various downstream components such as a shared scalable, elastic file storage (EFS) service; credentials for authentication, authorization, and accounting (AAA) or combination thereof, which may make use of an identity and access management (IAM) service; any suitable data source, such as data storage services, serverless, interactive query services, cloud data warehouse services, and more. The API server may be dedicated to a single instance/session. The API server may be configured with a grant of access to the compute engine to send requests (e.g., either collocate or being able to connect to it). Architecturally, a place to host the compute engine on a dedicated LL instance with flexible instance type selection may be utilized, in at least one embodiment. In some cases, components have OE features such as production monitoring, logging, alarming, any combination thereof, and more. Components may have dev environments available for productivity. Components may be deployed to various stacks in a deployment pipeline, such as beta, gamma, prod stacks, via a self-managed pipeline.

A data selection component may be a lightweight software application or component thereof to process and manage small amounts of data for preview and delegate work to hosted services, such as downstream data stores. A data selection component may generate dataset definitions as its main artifact/output and pass it around to downstream components which may process the data at scale. In at least one embodiment, a data selection component is implemented using at least one Jupyter Service Extension. A data selection server may spawn up a server extension (which in turn may proxy to another process that runs the actual server program). The integrated ML environment 202 may send requests via HTTPS to the data selection server extension. In some embodiments, a data selection server is bundled together with data transformation and compute container, as described in greater detail below.

A data transformation component, in accordance with at least one embodiment, may be a lightweight proxy extension that redirects frontend requests to a customized kernel gateway application running on a dedicated compute service instance, such as the kernel container 204 illustrated in FIG. 2 and/or the kernel container 130 illustrated in FIG. 1. In at least one embodiment, the customized kernel gateway application container includes both the data transformation APIs, execution engine and, optionally, the data selection server implementations. Any suitable transport protocol may be used, such as HTTPS or WSS (WebSocket Secure) to communicate with the kernel gateway container.

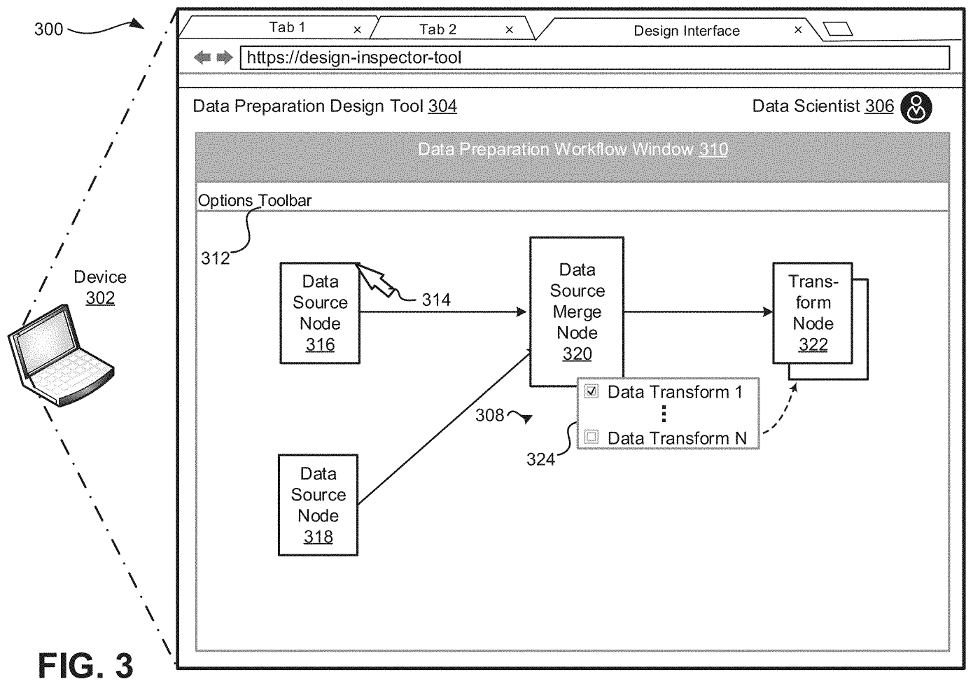

FIG. 3 illustrates a computing environment 300 that includes at least one client computing device 302 that provides a UI, according to at least one embodiment. The client computing device 302 can be implemented in the same manner as the frontend computing device 102 illustrated in FIG. 1 and/or the integrated ML environment 202 illustrated in FIG. 2. Therefore, the client computing device 302 is functional to operate in accordance with the described operational functionalities associated with the frontend computing device 102 and/or the integrated ML environment 202.

In at least one embodiment, the client computing device 302 provides a data preparation design tool 304 that is displayed in a browser window or other suitable UI. The data preparation design tool 304 can comprise some or all of the functionalities associated with the data preparation design tool 110 illustrated in FIG. 1. A data scientist 306 can interface with the data preparation design tool 304 to create a graph 308 within a data preparation workflow window 310 of the data preparation design tool 304. An operations toolbar 312 of the data preparation design tool 304 can be used to add graph nodes to the graph 308. The data scientist 306 can use a pointer 314 to interface with the options toolbar 312, which facilitates adding and/or removing nodes from the graph 308. The graph 308 is illustrated as including nodes 316, 318, 320, and 322. Each of the indicated nodes 316, 318, and 322 can have associated underlined syntax representations according to the embodiments described herein.

In at least one embodiment, the graph 308 is generated by the data scientist 306 to include a data source merge node 320. The data scientist 306 can generate the data source merge node 320 by, in at least one embodiment, selecting to merge the data associated with the data source node 316 and the data source node 318 to generate a merged data set that corresponds to the data source merge node 320. Merging of data sets can be facilitated through an option in the options toolbar 312. The merged data associated with the data source merge node 320 can be modified, conditioned, and/or cleaned through the selection of one or more data transforms provided in a data transform sub-window 324 that is accessible using the pointer 314.

In at least one embodiment, the options toolbar can provide a user selection to convert the graph 308 to executable code. For example, when the options toolbar is selected by the data scientist 306, an option can be presented to convert the graph 308 to a code representation that can be executed by one or more computing devices, such as the device 302. In at least one embodiment, the data preparation design tool 304 supports converting the graph 308 to Python code, such as pandas or Dask, Spark, C++, Java, Javascript, Haskell, and so forth. The code representation based on the converted graph 308 can be displayed in the data preparation workflow window 310, stored locally in the device 302, and/or hosted by or stored in compute resources of the backend, such as computer resources of the backend computing device 104 and/or the backend computing resources implementing the kernel container 204.

In at least one embodiment, the data preparation design tool 304 can allow the data scientist 306 to specify the programming code, language, or computer-executable instructions, that will be generated when the data scientist 306 selects to convert the graph 308 to a code representation. For example, one or more backend compute resources, such as compute resources of the backend computing device 104 and/or the backend computing resources hosting the kernel container 204, can store or have access to one or more programming languages that can be used to convert the graph 308 and its underlying syntax to a code representation. The one or more programming languages that can be used to convert the graph 308 to a code representation can be provided by the data scientist 306, so that the data preparation design tool 304 is functional to convert the graph 308 to a user selected code representation. Alternatively, or in addition, the one or more backend compute resources can interrogate internal and/or external compute resources to locate the programming code, language, or computer-executable instructions associated with the programming code, language, or computer-executable instructions specified to be used when converting the graph 308 to a code representation.

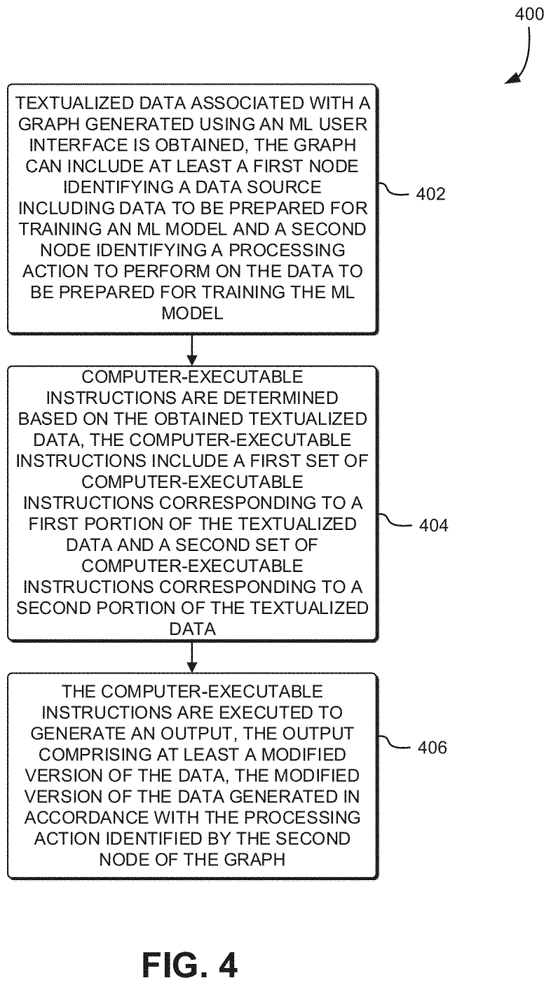

FIG. 4 illustrates an example flow diagram 400 that may be associated with one or more of the described system environments, for generation and use of graphs to produce modified data usable for training machine learning models, according to at least one embodiment. In some implementations, the acts of the flow diagram 400 are executed by one or more computing devices of the example system environments 100, 200 and/or 300. The example system environments 100, 200 and/or 300 may execute computer-executable instructions incorporating at least some of the processing acts of the flow diagram 400 to provide generation and use of one or more graphs according to at least one of the embodiments described herein.

The particular implementation of the technologies disclosed herein is a matter of choice dependent on the performance and other requirements of the computing device. Accordingly, the logical operations, also referred to as acts, described herein are referred to variously as states, operations, structural devices, acts, or modules. These states, operations, structural devices, acts and modules can be implemented in hardware, software, firmware, in special-purpose digital logic, and any combination thereof. It should be appreciated that more or fewer operations can be performed than shown in the FIGS. and described herein. These operations can also be performed in a different order than those described herein. It should also be understood that the methods described herein can be ended at any time and need not be performed in their entireties.

Some or all operations of the methods described herein, and/or substantially equivalent operations, can be performed by execution of computer-readable instructions included on a computer-storage media. The term “computer-readable instructions,” and variants thereof, as used in the description and claims, is used expansively herein to include routines, applications, application modules, program modules, system modules, programs, components, data structures, algorithms, and the like. Computer-readable instructions can be implemented on various system configurations, including single-processor or multiprocessor systems, minicomputers, mainframe computers, distributed computer systems, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules might be implemented in software, in firmware, in special purpose digital logic, and any combination thereof.

At 402, textualized data associated with a graph generated using an ML UI is obtained. The graph can include at least a first node identifying a data source comprising data to be prepared for training an ML model and a second node identifying a processing action to perform on the data to be prepared for training the ML model. In at least one embodiment, the graph is generated by a frontend computing device, such as the frontend computing device 102 illustrated in FIG. 1 and/or a computing device that provides the integrated ML environment 202. The textualized data associated with a graph can be obtained by a backend computing device, such as the backend computing device 104 illustrated in FIG. 1 and/or a backend computing device implementing the kernel container 204 illustrated in FIG. 2.

At 404, computer-executable instructions are determined based on the obtained textualized data. The computer-executable instructions can include a first set of computer-executable instructions corresponding to a first portion of the textualized data and a second set of computer-executable instructions corresponding to a second portion of the textualized data. In at least one embodiment, the computer-executable instructions can be determined by a backend computing device, such as the backend computing device 104 illustrated in FIG. 1 and/or a backend computing device implementing the kernel container 204 illustrated in FIG. 2.

At 406, the computer-executable instructions are executed to generate an output. The output can include at least a modified version of the data, the modified version of the data generated in accordance with the processing action identified by the second node of the graph. The computer-executable instructions can be executed by a backend computing device, such as the backend computing device 104 illustrated in FIG. 1 and/or a backend computing device implementing the kernel container 204 illustrated in FIG. 2.

In at least one embodiment, the flow diagram 400 can be augmented to include analyzing the computer-executable instructions to determine a decorator to be added to the first set of computer-executable instructions or the second set of computer-executable instructions, and/or adding the decorator to the first set of computer-executable instructions or the second set of computer-executable instruction before executing the computer-executable instructions to generate the output. In at least one embodiment, a backend computing device, such as the backend computing device 104 illustrated in FIG. 1 and/or a backend computing device implementing the kernel container 204 illustrated in FIG. 2, can be used to perform the described analyzing and/or adding actions.

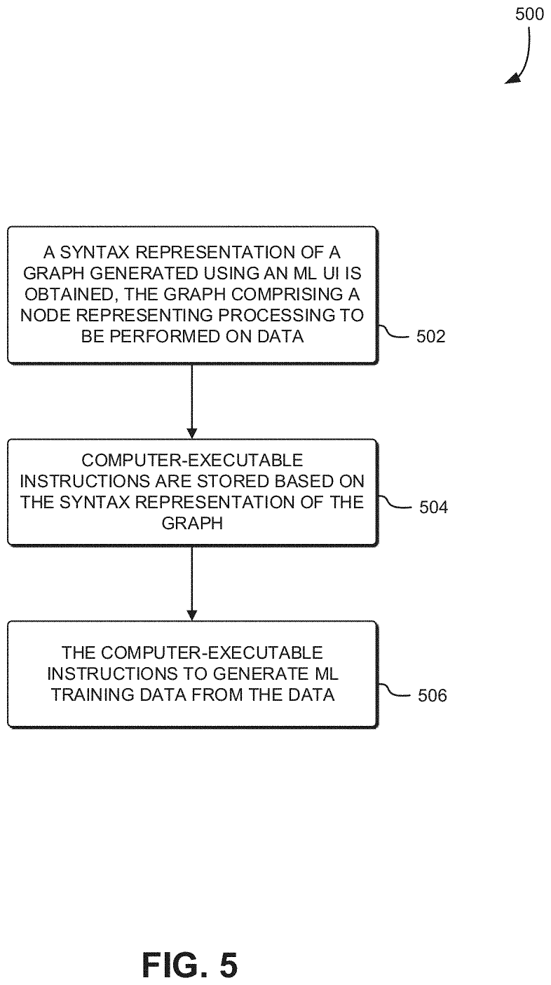

FIG. 5 illustrates an example flow diagram 500 that may be associated with one or more of the described system environments, for generation and use of graphs to produce modified data usable for training machine learning models, according to at least one embodiment. In some implementations, the acts of the flow diagram 500 are executed by one or more computing devices of the example system environments 100, 200 and/or 300. The example system environments 100, 200 and/or 300 may execute computer-executable instructions incorporating at least some of the processing acts of the flow diagram 500 to provide generation and use of one or more graphs according to at least one of the embodiments described herein.

At 502, a syntax representation of a graph generated using an ML UI is obtained. The graph can include a node representing processing to be performed on data. In at least one embodiment, the graph is generated by a frontend computing device, such as the frontend computing device 102 illustrated in FIG. 1 and/or a computing device that provides the integrated ML environment 202. The syntax representation of the graph can be obtained by a backend computing device, such as the backend computing device 104 illustrated in FIG. 1 and/or a backend computing device implementing the kernel container 204 illustrated in FIG. 2.

At 504, computer-executable instructions based on the syntax representation of the graph are stored. In at least one embodiment, a backend computing device, such as the backend computing device 104 illustrated in FIG. 1 and/or a backend computing device implementing the kernel container 204 illustrated in FIG. 2, can store the computer-executable instructions. In at least one embodiment, storing the computer-executable instructions can comprise retrieving the computer-executable instructions from nonvolatile memory and storing the computer-executable instructions and volatile memory in a ready state for execution by a processor of the backend computing device.

In at least one embodiment, the flow diagram 500 can be augmented to include determining the function name comprised in the text, locating the computer-executable instructions based on the function name comprised in the text, and loading the computer-executable instructions into RAM. In addition, the flow diagram 500 can be augmented to include generating a message comprising the ML training data and the node ID, and transmitting the message comprising the ML training data and the node ID to a client computing device, the message usable by the client computing device to cause the client computing device to display the ML training data, based on at least the node ID, in the ML UI. Furthermore, the flow diagram 500 can be augmented to include transmitting the ML training data to a client computing device, at least a portion of the ML training data to be displayed in the ML UI, and retrieving the data from the data source based on determining a location of the data source from a portion of the syntax representation that identifies the data source storing the data, and wherein the computer-executable instructions use the retrieved data to generate the ML training data. In at least one embodiment, a backend computing device, such as the backend computing device 104 illustrated in FIG. 1 and/or a backend computing device implementing the kernel container 204 illustrated in FIG. 2, can be used to perform the functions or actions described in the foregoing.

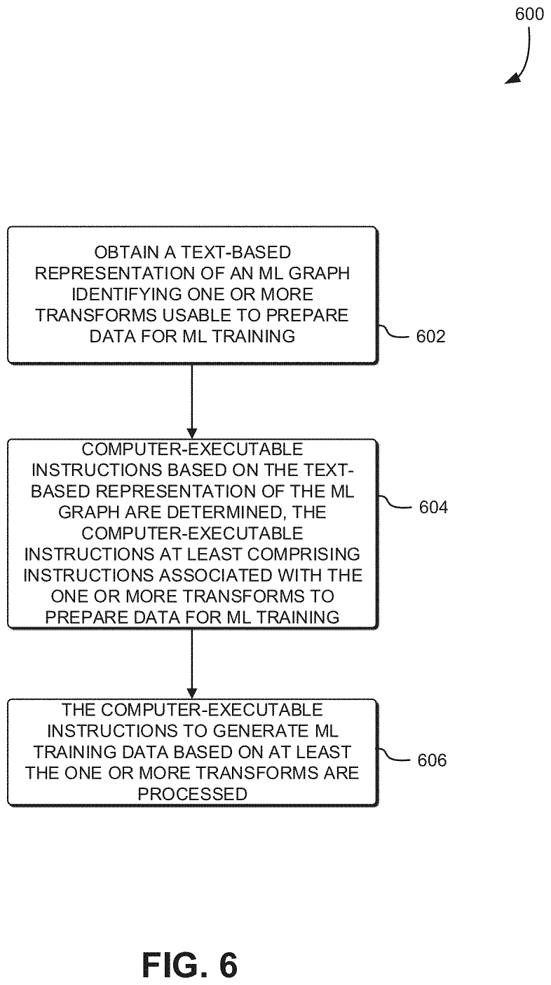

FIG. 6 illustrates an example flow diagram 600 that may be associated with one or more of the described system environments, for generation and use of graphs to produce modified data usable for training machine learning models, according to at least one embodiment. In some implementations, the acts of the flow diagram 600 are executed by one or more computing devices of the example system environments 100, 200 and/or 300. The example system environments 100, 200 and/or 300 may execute computer-executable instructions incorporating at least some of the processing acts of the flow diagram 600 to provide generation and use of one or more graphs according to at least one of the embodiments described herein.

At 602, a text-based representation of an ML graph identifying one or more transforms usable to prepare data for ML training. In at least one embodiment, the ML graph is generated by a frontend computing device, such as the frontend computing device 102 illustrated in FIG. 1 and/or a computing device that provides the integrated ML environment 202. The text-based representation of the ML graph can be obtained by a backend computing device, such as the backend computing device 104 illustrated in FIG. 1 and/or a backend computing device implementing the kernel container 204 illustrated in FIG. 2.

At 604, computer-executable instructions based on the text-based representation of the ML graph are determined. The computer-executable instructions can include instructions associated with the one or more transforms to prepare data for ML training. In at least one embodiment, a backend computing device, such as the backend computing device 104 illustrated in FIG. 1 and/or a backend computing device implementing the kernel container 204 illustrated in FIG. 2, can determine the computer-executable instructions. In at least one embodiment, determining the computer-executable instructions can include locating the computer-executable instructions from nonvolatile memory and storing the computer-executable instructions and volatile memory in a ready state for execution by a processor of the backend computing device.

At 606, the computer-executable instructions to generate ML training data based on at least the one or more transforms are processed. In at least one embodiment, a backend computing device, such as the backend computing device 104 illustrated in FIG. 1 and/or a backend computing device implementing the kernel container 204 illustrated in FIG. 2, can process the computer-executable instructions. In at least one embodiment, processing the computer-executable instructions includes causing a processor to execute the computer-executable instructions to generate the ML training data based on at least the one or more transforms. In at least one embodiment, processing the computer-executable instructions includes causing one or more processors to compile and execute the computer-executable instructions to generate the ML training data based on at least the one or more transforms.

In at least one embodiment, the flow diagram 600 can be augmented to include transmitting the generated ML training data to a client computing device that caused the computer system to obtain the text-based representation of the ML graph, and/or associating a decorator with the computer-executable instructions determined based on the text-based representation of the ML graph, the decorator augmenting the computer-executable instructions to generate the ML training data based on at least the one or more transforms. In at least one embodiment, the flow diagram 600 can be augmented to include generating a message comprising the ML training data, and/or transmitting the message comprising the ML training data to a client computing device, the message usable by the client computing device to cause the client computing device to display the ML training data.

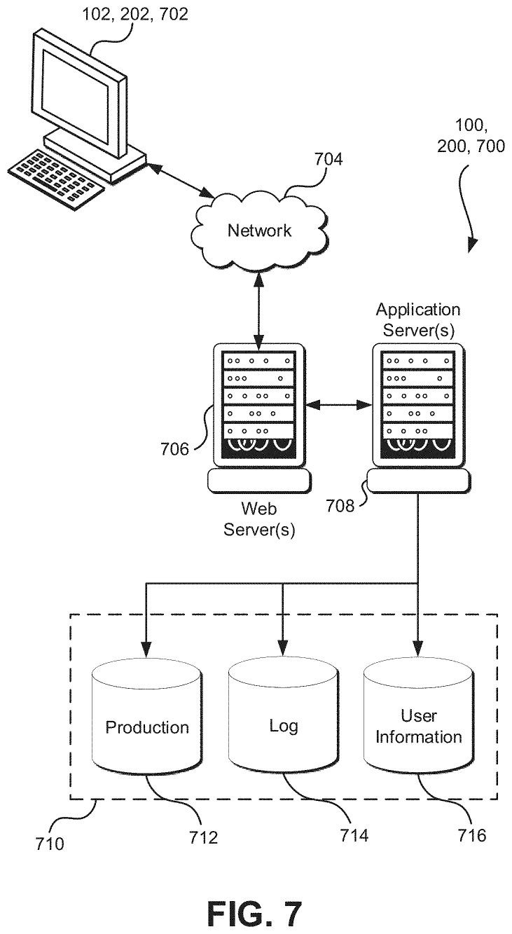

FIG. 7 illustrates aspects of an example system 700 for implementing aspects in accordance with an embodiment. As will be appreciated, although a web-based system is used for purposes of explanation, different systems may be used, as appropriate, to implement various embodiments. In an embodiment, the system includes an electronic client device 702, which includes any appropriate device operable to send and/or receive requests, messages, or information over an appropriate network 704 and convey information back to a user of the device. Examples of such client devices include personal computers, cellular or other mobile phones, handheld messaging devices, laptop computers, tablet computers, set-top boxes, personal data assistants, embedded computer systems, electronic book readers, and the like. In an embodiment, the network includes any appropriate network, including an intranet, the Internet, a cellular network, a local area network, a satellite network or any other such network and/or combination thereof, and components used for such a system depend at least in part upon the type of network and/or system selected. Many protocols and components for communicating via such a network are well known and will not be discussed herein in detail. In an embodiment, communication over the network is enabled by wired and/or wireless connections and combinations thereof. In an embodiment, the network includes the Internet and/or other publicly addressable communications network, as the system includes a web server 706 for receiving requests and serving content in response thereto, although for other networks an alternative device serving a similar purpose could be used as would be apparent to one of ordinary skill in the art.

In an embodiment, the illustrative system includes at least one application server 708 and a data store 710, and it should be understood that there can be several application servers, layers or other elements, processes or components, which may be chained or otherwise configured, which can interact to perform tasks such as obtaining data from an appropriate data store. Servers, in an embodiment, are implemented as hardware devices, virtual computer systems, programming modules being executed on a computer system, and/or other devices configured with hardware and/or software to receive and respond to communications (e.g., web service application programming interface (API) requests) over a network. As used herein, unless otherwise stated or clear from context, the term “data store” refers to any device or combination of devices capable of storing, accessing and retrieving data, which may include any combination and number of data servers, databases, data storage devices and data storage media, in any standard, distributed, virtual or clustered system. Data stores, in an embodiment, communicate with block-level and/or object-level interfaces. The application server can include any appropriate hardware, software and firmware for integrating with the data store as needed to execute aspects of one or more applications for the client device, handling some or all of the data access and business logic for an application.

In an embodiment, the application server provides access control services in cooperation with the data store and generates content including but not limited to text, graphics, audio, video and/or other content that is provided to a user associated with the client device by the web server in the form of HyperText Markup Language (“HTML”), Extensible Markup Language (“XML”), JavaScript, Cascading Style Sheets (“CSS”), JavaScript Object Notation (JSON), and/or another appropriate client-side or other structured language. Content transferred to a client device, in an embodiment, is processed by the client device to provide the content in one or more forms including but not limited to forms that are perceptible to the user audibly, visually and/or through other senses. The handling of all requests and responses, as well as the delivery of content between the client device 702 and the application server 708, in an embodiment, is handled by the web server using PHP: Hypertext Preprocessor (“PHP”), Python, Ruby, Perl, Java, HTML, XML, JSON, and/or another appropriate server-side structured language in this example. In an embodiment, operations described herein as being performed by a single device are performed collectively by multiple devices that form a distributed and/or virtual system.

The data store 710, in an embodiment, includes several separate data tables, databases, data documents, dynamic data storage schemes and/or other data storage mechanisms and media for storing data relating to a particular aspect of the present disclosure. In an embodiment, the data store illustrated includes mechanisms for storing production data 712 and user information 716, which are used to serve content for the production side. The data store also is shown to include a mechanism for storing log data 714, which is used, in an embodiment, for reporting, computing resource management, analysis or other such purposes. In an embodiment, other aspects such as page image information and access rights information (e.g., access control policies or other encodings of permissions) are stored in the data store in any of the above listed mechanisms as appropriate or in additional mechanisms in the data store 710.

The data store 710, in an embodiment, is operable, through logic associated therewith, to receive instructions from the application server 708 and obtain, update or otherwise process data in response thereto, and the application server 708 provides static, dynamic, or a combination of static and dynamic data in response to the received instructions. In an embodiment, dynamic data, such as data used in web logs (blogs), shopping applications, news services, and other such applications, are generated by server-side structured languages as described herein or are provided by a content management system (“CMS”) operating on or under the control of the application server. In an embodiment, a user, through a device operated by the user, submits a search request for a certain type of item. In this example, the data store accesses the user information to verify the identity of the user, accesses the catalog detail information to obtain information about items of that type, and returns the information to the user, such as in a results listing on a web page that the user views via a browser on the user device 702. Continuing with this example, information for a particular item of interest is viewed in a dedicated page or window of the browser. It should be noted, however, that embodiments of the present disclosure are not necessarily limited to the context of web pages, but are more generally applicable to processing requests in general, where the requests are not necessarily requests for content. Example requests include requests to manage and/or interact with computing resources hosted by the system 700 and/or another system, such as for launching, terminating, deleting, modifying, reading, and/or otherwise accessing such computing resources.

In an embodiment, each server typically includes an operating system that provides executable program instructions for the general administration and operation of that server and includes a computer-readable storage medium (e.g., a hard disk, random access memory, read only memory, etc.) storing instructions that, if executed by a processor of the server, cause or otherwise allow the server to perform its intended functions (e.g., the functions are performed as a result of one or more processors of the server executing instructions stored on a computer-readable storage medium).

The system 700, in an embodiment, is a distributed and/or virtual computing system utilizing several computer systems and components that are interconnected via communication links (e.g., transmission control protocol (TCP) connections and/or transport layer security (TLS) or other cryptographically protected communication sessions), using one or more computer networks or direct connections. However, it will be appreciated by those of ordinary skill in the art that such a system could operate in a system having fewer or a greater number of components than are illustrated in FIG. 7. Thus, the depiction of the system 700 in FIG. 7 should be taken as being illustrative in nature and not limiting to the scope of the disclosure.

The various embodiments further can be implemented in a wide variety of operating environments, which in some cases can include one or more user computers, computing devices or processing devices that can be used to operate any of a number of applications. In an embodiment, user or client devices include any of a number of computers, such as desktop, laptop or tablet computers running a standard operating system, as well as cellular (mobile), wireless and handheld devices running mobile software and capable of supporting a number of networking and messaging protocols, and such a system also includes a number of workstations running any of a variety of commercially available operating systems and other known applications for purposes such as development and database management. In an embodiment, these devices also include other electronic devices, such as dummy terminals, thin-clients, gaming systems and other devices capable of communicating via a network, and virtual devices such as virtual machines, hypervisors, software containers utilizing operating-system level virtualization and other virtual devices or non-virtual devices supporting virtualization capable of communicating via a network.

In an embodiment, a system utilizes at least one network that would be familiar to those skilled in the art for supporting communications using any of a variety of commercially available protocols, such as Transmission Control Protocol/Internet Protocol (“TCP/IP”), User Datagram Protocol (“UDP”), protocols operating in various layers of the Open System Interconnection (“OSI”) model, File Transfer Protocol (“FTP”), Universal Plug and Play (“UpnP”), Network File System (“NFS”), Common Internet File System (“CIFS”) and other protocols. The network, in an embodiment, is a local area network, a wide-area network, a virtual private network, the Internet, an intranet, an extranet, a public switched telephone network, an infrared network, a wireless network, a satellite network, and any combination thereof. In an embodiment, a connection-oriented protocol is used to communicate between network endpoints such that the connection-oriented protocol (sometimes called a connection-based protocol) is capable of transmitting data in an ordered stream. In an embodiment, a connection-oriented protocol can be reliable or unreliable. For example, the TCP protocol is a reliable connection-oriented protocol. Asynchronous Transfer Mode (“ATM”) and Frame Relay are unreliable connection-oriented protocols. Connection-oriented protocols are in contrast to packet-oriented protocols such as UDP that transmit packets without a guaranteed ordering.

In an embodiment, the system utilizes a web server that runs one or more of a variety of server or mid-tier applications, including Hypertext Transfer Protocol (“HTTP”) servers, FTP servers, Common Gateway Interface (“CGI”) servers, data servers, Java servers, Apache servers, and business application servers. In an embodiment, the one or more servers are also capable of executing programs or scripts in response to requests from user devices, such as by executing one or more web applications that are implemented as one or more scripts or programs written in any programming language, such as Java®, C, C# or C++, or any scripting language, such as Ruby, PHP, Perl, Python or TCL, as well as combinations thereof. In an embodiment, the one or more servers also include database servers, including without limitation those commercially available from Oracle®, Microsoft®, Sybase®, and IBM® as well as open-source servers such as MySQL, Postgres, SQLite, MongoDB, and any other server capable of storing, retrieving, and accessing structured or unstructured data. In an embodiment, a database server includes table-based servers, document-based servers, unstructured servers, relational servers, non-relational servers, or combinations of these and/or other database servers.

In an embodiment, the system includes a variety of data stores and other memory and storage media as discussed above that can reside in a variety of locations, such as on a storage medium local to (and/or resident in) one or more of the computers or remote from any or all of the computers across the network. In an embodiment, the information resides in a storage-area network (“SAN”) familiar to those skilled in the art and, similarly, any necessary files for performing the functions attributed to the computers, servers or other network devices are stored locally and/or remotely, as appropriate. In an embodiment where a system includes computerized devices, each such device can include hardware elements that are electrically coupled via a bus, the elements including, for example, at least one central processing unit (“CPU” or “processor”), at least one input device (e.g., a mouse, keyboard, controller, touch screen, or keypad), at least one output device (e.g., a display device, printer, or speaker), at least one storage device such as disk drives, optical storage devices, and solid-state storage devices such as random access memory (“RAM”) or read-only memory (“ROM”), as well as removable media devices, memory cards, flash cards, etc., and various combinations thereof.

In an embodiment, such a device also includes a computer-readable storage media reader, a communications device (e.g., a modem, a network card (wireless or wired), an infrared communication device, etc.), and working memory as described above where the computer-readable storage media reader is connected with, or configured to receive, a computer-readable storage medium, representing remote, local, fixed, and/or removable storage devices as well as storage media for temporarily and/or more permanently containing, storing, transmitting, and retrieving computer-readable information. In an embodiment, the system and various devices also typically include a number of software applications, modules, services, or other elements located within at least one working memory device, including an operating system and application programs, such as a client application or web browser. In an embodiment, customized hardware is used and/or particular elements are implemented in hardware, software (including portable software, such as applets), or both. In an embodiment, connections to other computing devices such as network input/output devices are employed.

In an embodiment, storage media and computer readable media for containing code, or portions of code, include any appropriate media known or used in the art, including storage media and communication media, such as but not limited to volatile and non-volatile, removable and non-removable media implemented in any method or technology for storage and/or transmission of information such as computer readable instructions, data structures, program modules or other data, including RAM, ROM, Electrically Erasable Programmable Read-Only Memory (“EEPROM”), flash memory or other memory technology, Compact Disc Read-Only Memory (“CD-ROM”), digital versatile disk (DVD) or other optical storage, magnetic cassettes, magnetic tape, magnetic disk storage or other magnetic storage devices or any other medium which can be used to store the desired information and which can be accessed by the system device. Based on the disclosure and teachings provided herein, a person of ordinary skill in the art will appreciate other ways and/or methods to implement the various embodiments.

In various embodiments described throughout this disclosure, computing resources are configured to perform tasks (e.g., generate data, process data, store data, route messages, transmit data, submit requests, process requests) by loading computer-readable executable instructions into memory that, as a result of execution by one or more processors, cause the one or more processors to execute instructions to perform tasks. In at least one embodiment, a computer system is configured to perform a task through a software application that controls the execution of specific commands, requests, tasks, jobs, and more. A computer system may be configured to execute computer-readable instructions encoded in a software application by loading executable code of the software application into memory and using one or more processors of the computer system to run the executable instructions.

The specification and drawings are, accordingly, to be regarded in an illustrative rather than a restrictive sense. It will, however, be evident that various modifications and changes may be made thereunto without departing from the broader spirit and scope of the subject matter set forth in the claims.

Other variations are within the spirit of the present disclosure. Thus, while the disclosed techniques are susceptible to various modifications and alternative constructions, certain illustrated embodiments thereof are shown in the drawings and have been described above in detail. It should be understood, however, that there is no intention to limit the subject matter recited by the claims to the specific form or forms disclosed but, on the contrary, the intention is to cover all modifications, alternative constructions, and equivalents falling within the spirit and scope of this disclosure, as defined in the appended claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. Similarly, use of the term “or” is to be construed to mean “and/or” unless contradicted explicitly or by context. The terms “comprising,” “having,” “including,” and “containing” are to be construed as open-ended terms (i.e., meaning “including, but not limited to,”) unless otherwise noted. The term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. The use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but the subset and the corresponding set may be equal. The use of the phrase “based on,” unless otherwise explicitly stated or clear from context, means “based at least in part on” and is not limited to “based solely on.”

Conjunctive language, such as phrases of the form “at least one of A, B, and C,” or “at least one of A, B and C,” (i.e., the same phrase with or without the Oxford comma) unless specifically stated otherwise or otherwise clearly contradicted by context, is otherwise understood within the context as used in general to present that an item, term, etc., may be either A or B or C, any nonempty subset of the set of A and B and C, or any set not contradicted by context or otherwise excluded that contains at least one A, at least one B, or at least one C. For instance, in the illustrative example of a set having three members, the conjunctive phrases “at least one of A, B, and C” and “at least one of A, B and C” refer to any of the following sets: {A}, {B}, {C}, {A, B}, {A, C}, {B, C}, {A, B, C}, and, if not contradicted explicitly or by context, any set having {A}, {B}, and/or {C} as a subset (e.g., sets with multiple “A”). Thus, such conjunctive language is not generally intended to imply that certain embodiments require at least one of A, at least one of B and at least one of C each to be present. Similarly, phrases such as “at least one of A, B, or C” and “at least one of A, B or C” refer to the same as “at least one of A, B, and C” and “at least one of A, B and C” refer to any of the following sets: {A}, {B}, {C}, {A, B}, {A, C}, {B, C}, {A, B, C}, unless differing meaning is explicitly stated or clear from context. In addition, unless otherwise noted or contradicted by context, the term “plurality” indicates a state of being plural (e.g., “a plurality of items” indicates multiple items). The number of items in a plurality is at least two but can be more when so indicated either explicitly or by context.

Operations of processes described herein can be performed in any suitable order unless otherwise indicated herein or otherwise clearly contradicted by context. In an embodiment, a process such as those processes described herein (or variations and/or combinations thereof) is performed under the control of one or more computer systems configured with executable instructions and is implemented as code (e.g., executable instructions, one or more computer programs or one or more applications) executing collectively on one or more processors, by hardware or combinations thereof. In an embodiment, the code is stored on a computer-readable storage medium, for example, in the form of a computer program comprising a plurality of instructions executable by one or more processors. In an embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In an embodiment, code (e.g., executable code or source code) is stored on a set of one or more non-transitory computer-readable storage media having stored thereon executable instructions that, when executed (i.e., as a result of being executed) by one or more processors of a computer system, cause the computer system to perform operations described herein. The set of non-transitory computer-readable storage media, in an embodiment, comprises multiple non-transitory computer-readable storage media, and one or more of individual non-transitory storage media of the multiple non-transitory computer-readable storage media lack all of the code while the multiple non-transitory computer-readable storage media collectively store all of the code. In an embodiment, the executable instructions are executed such that different instructions are executed by different processors—for example, in an embodiment, a non-transitory computer-readable storage medium stores instructions and a main CPU executes some of the instructions while a graphics processor unit executes other instructions. In another embodiment, different components of a computer system have separate processors and different processors execute different subsets of the instructions.

Accordingly, in an embodiment, computer systems are configured to implement one or more services that singly or collectively perform operations of processes described herein, and such computer systems are configured with applicable hardware and/or software that enable the performance of the operations. Further, a computer system, in an embodiment of the present disclosure, is a single device and, in another embodiment, is a distributed computer system comprising multiple devices that operate differently such that the distributed computer system performs the operations described herein and such that a single device does not perform all operations.

The use of any and all examples or exemplary language (e.g., “such as”) provided herein is intended merely to better illuminate various embodiments and does not pose a limitation on the scope of the claims unless otherwise claimed. No language in the specification should be construed as indicating any non-claimed element as essential to the practice of inventive subject material disclosed herein.

Embodiments of this disclosure are described herein, including the best mode known to the inventors for carrying out inventive concepts described herein. Variations of those embodiments may become apparent to those of ordinary skill in the art upon reading the foregoing description. The inventors expect skilled artisans to employ such variations as appropriate, and the inventors intend for embodiments of the present disclosure to be practiced otherwise than as specifically described herein. Accordingly, the scope of the present disclosure includes all modifications and equivalents of the subject matter recited in the claims appended hereto as permitted by applicable law. Moreover, any combination of the above-described elements in all possible variations thereof is encompassed by the scope of the present disclosure unless otherwise indicated herein or otherwise clearly contradicted by context.

All references including publications, patent applications, and patents cited herein are hereby incorporated by reference to the same extent as if each reference were individually and specifically indicated to be incorporated by reference and were set forth in its entirety herein.

What is claimed is:

1. A computer-implemented method, comprising:
obtaining textualized data associated with a graph generated using a machine learning (ML) user interface, the graph comprising at least a first node identifying a data source comprising data to be prepared for training an ML model and a second node identifying a processing action to perform on the data to be prepared for training the ML model;
determining computer-executable instructions based on the obtained textualized data, the computer-executable instructions comprising a first set of computer-executable instructions corresponding to a first portion of the textualized data and a second set of computer-executable instructions corresponding to a second portion of the textualized data; and
executing the computer-executable instructions to generate an output, the output comprising at least a modified version of the data, the modified version of the data generated in accordance with the processing action identified by the second node of the graph.

2. The computer-implemented method according to claim 1, wherein the first portion of the textualized data is associated with the first node of the graph and the second portion of the textualized data is associated with the second node of the graph.

3. The computer-implemented method according to claim 1, further comprising:
analyzing the computer-executable instructions to determine a decorator to be added to the first set of computer-executable instructions or the second set of computer-executable instructions; and
adding the decorator to the first set of computer-executable instructions or the second set of computer-executable instruction before executing the computer-executable instructions to generate the output.

4. The computer-implemented method according to claim 1, further comprising obtaining information indicating a user selected mode usable to determine a quantity of modified version of the data to include in the output.

5. A system, comprising:
one or more processors; and
memory that stores computer-executable instructions that are executable by the one or more processors to cause the system to:
obtain a syntax representation of a graph generated using a machine learning (ML) user interface (UI), the graph comprising a node representing processing to be performed on data;
store computer-executable instructions based on the syntax representation of the graph; and
execute the computer-executable instructions to generate ML training data from the data.

6. The system according to claim 5, wherein the syntax representation of the graph comprises text, the text comprising at least a node identifier (ID) for the node representing processing to be performed on the data and a function name.

7. The system according to claim 6, wherein storing the computer-executable instructions comprises:
determining the function name comprised in the text;
locating the computer-executable instructions based on the function name comprised in the text; and
loading the computer-executable into random-access memory (RAM).

8. The system according to claim 6, wherein the computer-executable instructions that are executable by the one or more processors to further cause the system to:
generate a message comprising the ML training data and the node ID; and
transmit the message comprising the ML training data and the node ID to a client computing device, the message usable by the client computing device to cause the client computing device to display the ML training data, based on at least the node ID, in the ML UI.

9. The system according to claim 5, wherein the computer-executable instructions that are executable by the one or more processors to further cause the system to:
transmit the ML training data to a client computing device, at least a portion of the ML training data to be displayed in the ML UI.

10. The system according to claim 5, wherein the processing to be performed on the data corresponds to at least one predefined transform function that, when executed, is to modify the data, the at least one predefined transform function comprising the computer-executable instructions stored and executed to generate the ML training data from the data.

11. The system according to claim 5, wherein the graph comprising the node representing processing to be performed on the data further comprises another node representing a data source storing the data, the obtained syntax representation of the graph identifying the data source storing the data.

12. The system according to claim 11, wherein the computer-executable instructions that are executable by the one or more processors to further cause the system to:
retrieve the data from the data source based on determining a location of the data source from a portion of the syntax representation that identifies the data source storing the data, and wherein the computer-executable instructions use the retrieved data to generate the ML training data.

13. A non-transitory computer-readable storage medium storing thereon executable instructions that, as a result of being executed by one or more processors of a computer system, cause the computer system to:
obtain a text-based representation of a machine learning (ML) graph identifying one or more transforms usable to prepare data for ML training;
determine computer-executable instructions based on the text-based representation of the ML graph, the computer-executable instructions at least comprising instructions associated with the one or more transforms to prepare data for ML training; and
process the computer-executable instructions to generate ML training data based on at least the one or more transforms.

14. The non-transitory computer-readable storage medium according to claim 13, wherein the text-based representation of the ML graph comprises a function name of the one or more transforms usable to prepare data for ML training.

15. The non-transitory computer-readable storage medium according to claim 14, wherein determining the computer-executable instructions comprises locating the computer-executable using the function name comprised in the text-based representation of the ML graph.

16. The non-transitory computer-readable storage medium according to claim 13, wherein the instructions further comprise instructions that, as a result of being executed by the one or more processors, cause the computer system to transmit the generated ML training data to a client computing device that caused the computer system to obtain the text-based representation of the ML graph.

17. The non-transitory computer-readable storage medium according to claim 13, wherein the obtained the text-based representation of the ML graph further identifies a portion of the ML graph corresponding to the one or more transforms usable to prepare the data for ML training.

18. The non-transitory computer-readable storage medium according to claim 13, wherein obtaining the text-based representation of the ML graph identifying the one or more transforms usable to prepare the data for ML training comprises:
receiving a message from a client computing device, the message containing text that identifies a node of the ML graph, an identifier of the one or more transforms usable to prepare the data for ML training, and a portion of the data that the one or more transforms is to transform when the computer-executable instructions associated with the one or more transforms are processed.

19. The non-transitory computer-readable storage medium according to claim 13, wherein the instructions further comprise instructions that, as a result of being executed by the one or more processors, cause the computer system to associate a decorator with the computer-executable instructions determined based on the text-based representation of the ML graph, the decorator augmenting the computer-executable instructions to generate the ML training data based on at least the one or more transforms.

20. The non-transitory computer-readable storage medium according to claim 13, wherein the instructions further comprise instructions that, as a result of being executed by the one or more processors, cause the computer system to:
generate a message comprising the ML training data; and
transmit the message comprising the ML training data to a client computing device, the message usable by the client computing device to cause the client computing device to display the ML training data.
